(19) United States
(12) Patent Application Publication
(10) Pub. No.: US 2016/0162643 A1
(43) Pub. Date: Jun. 9, 2016

(54) METHOD AND APPARATUS FOR CREATING AND UPDATING MEDICAL RECORDS

(71) Applicants: Robert J. Newbold, Canton, OH (US); Scott V. Watkins, Cumberland, MD (US)

(72) Inventors: Robert J. Newbold, Canton, OH (US); Scott V. Watkins, Cumberland, MD (US)

(21) Appl. No.: 14/563,717

(22) Filed: Dec. 8, 2014

(51) Int. Cl. G06F 19/00; G06F 17/30

(52) U.S. Cl. CPC G06F 19/323; G06F 17/30345

(57) ABSTRACT

An apparatus, system and method may provide for maintaining and updating a patient's medical records. A patient medical memory device may be assigned to a patient and used to store the patient's medical record, which may be accessible to a healthcare professional when visited by the patient. The medical record may be updated with new medical information derived from a visit with a healthcare professional by storing the new medical information in a memory of the memory device and/or in a remote computer database. A memory reader and writer may be provided to read and write to the memory.

### BACKGROUND OF THE INVENTION

1. Field of Invention

The current invention relates generally to apparatus, systems and methods for generating and updating medical records. More particularly, the apparatus, systems and methods relate to generating a comprehensive medical history of a particular medical patient. Specifically, the apparatus, systems and methods provide for a way to retrieve and update the medical history of a medical patient using a personal device assigned to that patient.

2. Description of Related Art

For years, medical patients have often checked in at a particular medical facility after filling out numerous forms related to their personal history, medical history and insurance coverage. Generally, each time a patient goes to a new doctor or a different medical facility for diagnosis and/or treatment of a different medical condition, the patient needs to completely fill out a new set of forms. This information then often needs to be retyped into the new medical facility's computer system. This process is time consuming and inefficient. Moreover, a given healthcare professional/medical facility does not have access to the patient's full medical history when the patient arrives, whereby the healthcare professional is at a disadvantage as to various aspects of the patient's medical history which may be important in more properly diagnosing and/or treating the patient. The present invention addresses these and other problems.

### SUMMARY

In one aspect, the invention may provide a method comprising the steps of reading with a memory reader a memory of a first patient medical memory device of a patient to access a medical record of the patient comprising a first set of medical information; and storing in the memory with a memory writer a second set of medical information to update the medical record, wherein the second set of medical information is derived from a visit of the patient with a healthcare professional at a first medical facility where the memory reader is located.

In another aspect, the invention may provide a method comprising the steps of maintaining in a computer database a medical record of a patient comprising a first set of medical information of the patient; providing a first patient medical memory device having a memory in which is stored the first set of medical information; receiving a second set of medical information of the patient from the memory; and updating the medical record by storing the second set of medical information in the database.

In another aspect, the invention may provide a system comprising a patient medical memory device having a memory in which is stored a first set of medical information of a patient to which the memory device is assigned; and a memory reader and writer capable of reading the memory to access the first set of medical information and writing to the memory to store a second set of medical information in the memory.

### BRIEF DESCRIPTION OF SEVERAL VIEWS OF THE DRAWINGS

One or more sample embodiments that illustrate the best mode(s) are set forth in the drawings and in the following description. The appended claims particularly and distinctly point out and set forth the invention.

The accompanying drawings, which are incorporated in and constitute a part of the specification, illustrate various sample methods, and other sample embodiments of various aspects of the invention. It will be appreciated that the illustrated element boundaries (e.g., boxes, groups of boxes, or other shapes) in the figures represent one sample of the boundaries. One of ordinary skill in the art will appreciate that in some samples one element may be designed as multiple elements or that multiple elements may be designed as one element. In some samples, an element shown as an internal component of another element may be implemented as an external component and vice versa. Furthermore, elements may not be drawn to scale.

FIG. 1A is a front view of a sample patient medical memory device.

FIG. 1B is a side view of the sample memory device.

FIG. 1C is a back view of the sample memory device.

FIG. 2 is a diagrammatic view of a sample network in which the sample memory device may operate.

FIG. 3 is a diagrammatic view of a sample computing device with which the memory device may operate.

FIG. 4 is a flow chart showing a sample method using the memory device.

FIG. 5 is a flow chart showing another sample method using the memory device.

Similar numbers refer to similar parts throughout the drawings.

### DETAILED DESCRIPTION

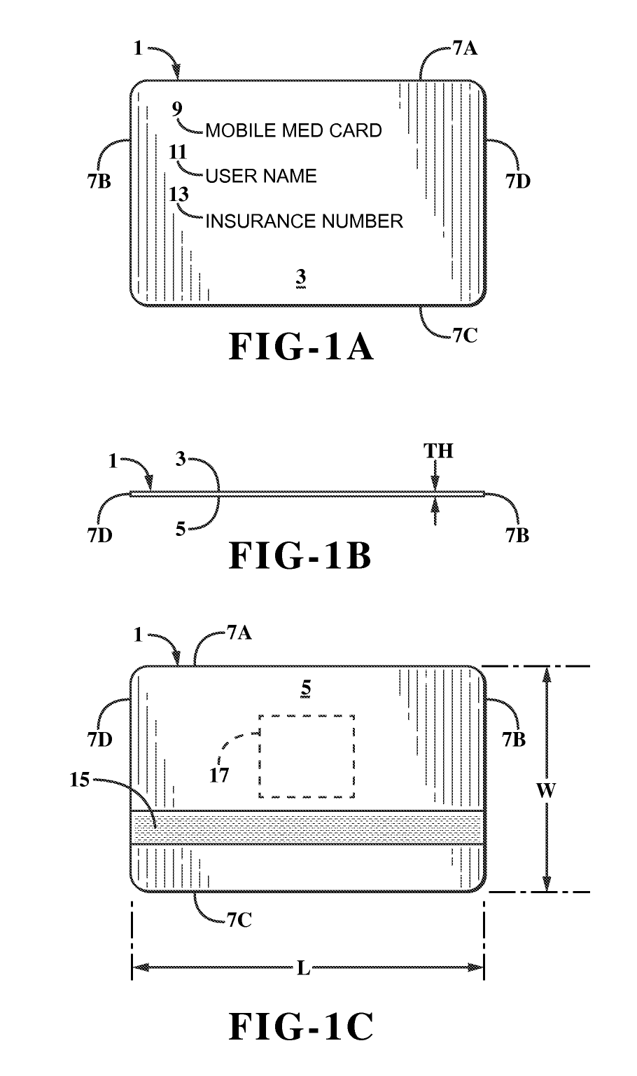

FIGS. 1A-C show a sample embodiment of a patient medical memory device 1 which is shown in the form of a mobile medical card and which has a machine readable and writable memory in which may be stored medical information of a particular person or patient. Card 1 may be generally about the size of a traditional credit card and may be made of durable plastic. Card 1 may have a front planar surface 3 and a back planar surface 5. Card 1 may be rectangular in shape and have a top or top edge 7A, a left side or side edge 7B, a bottom or bottom edge 7C and a right side or side edge 7D. Card 1 may have indicia or an indicator 9 on its front indicating it is card of a particular organization, here being shown as “Mobile Med Card.” Card 1 may include a name 11 of the patient, who may be the card's owner or possessor, as well as insurance and/or other basic medical account data 13.

As shown in FIGS. 1B and 1C, card 1 may have a normal length L defined between left and right side edges 7B and 7D, normal width defined between top and bottom edges 7A and 7C, and a normal thickness TH defined between front and back surfaces 3 and 5. Length L may be in a range of about 8.0 to about 9.0 centimeters (cm) and is often about 8.5 cm. Width W may be in a range of about 5.0 to about 6.0 cm and is often about 5.4 cm. Thickness TH may be in a range of about 0.5 to 1.5 or 2.0 millimeter(s) (mm) and is often about 1.0 mm. These dimensions may vary somewhat for a given card. Moreover, memory device 1 may come in a variety of forms which are different from a typical credit card. For instance, device 1 may be a memory stick or have dimensions similar to a memory stick, which may vary substantially. Such a memory stick may, for instance, have normal length in a range of about 3.0 to about 10.0 cm, a normal width in a range of about 1.5 to about 3.0 or 4.0 cm, and a thickness in a range of about 3.0 or 4.0 to about 10.0 mm. As will be appreciated, memory devices may vary in shape and size.

Regardless of the specific shape and size, memory device 1 is typically lightweight and fairly small so that it may be easily carried by a person or patient in one hand. Device 1 may be sized to fit within a wallet, a purse, a hand, a pants pocket or shirt pocket. Device 1 may have a hole formed therein or there may be a ring attached to device 1 so that device 1 may be attached to a key ring. Memory device 1 may have a weight which is no more than 0.2, 0.3, 0.4, 0.5, 0.6, 0.7, 0.8, 0.9, 1.0, 1.1, 1.2, 1.3, 1.4 or 1.5 ounce(s), or no more than 5, 10, 15, 20, 25, 30, 35, 40, 45 or 50 grams.

In addition to information which may be printed on the front or back of the card, the memory of memory device 1 provides a way for detailed medical information to be stored into and retrieved therefrom. For example, the memory of memory device 1 may be in the form of a magnetic strip 15 (FIG. 1C) secured to back 5 of device/card 1 that can be used to store the patient's or user's (owner or possessor of card 1) medical history as described in more detail later. The memory of memory device 1 may alternately (or additionally) be in the form of a radio frequency identification (RFID) tag or chip 17 onto which medical information can be securely written and from which such medical information may be retrieved by wireless methods. Chip 17 may be an internal chip such as a chip embedded within the card or other memory device. Those of ordinary skill in this art will appreciate that information such as medical information can be securely written and retrieved from memory device 1 in other ways. Also, while memory device 1 has been described as having an RFID chip 17 and/or a magnetic strip 15, it will be appreciated that device 1 may have other types of memory. Generally, the memory of device 1 is a readable and writable memory.

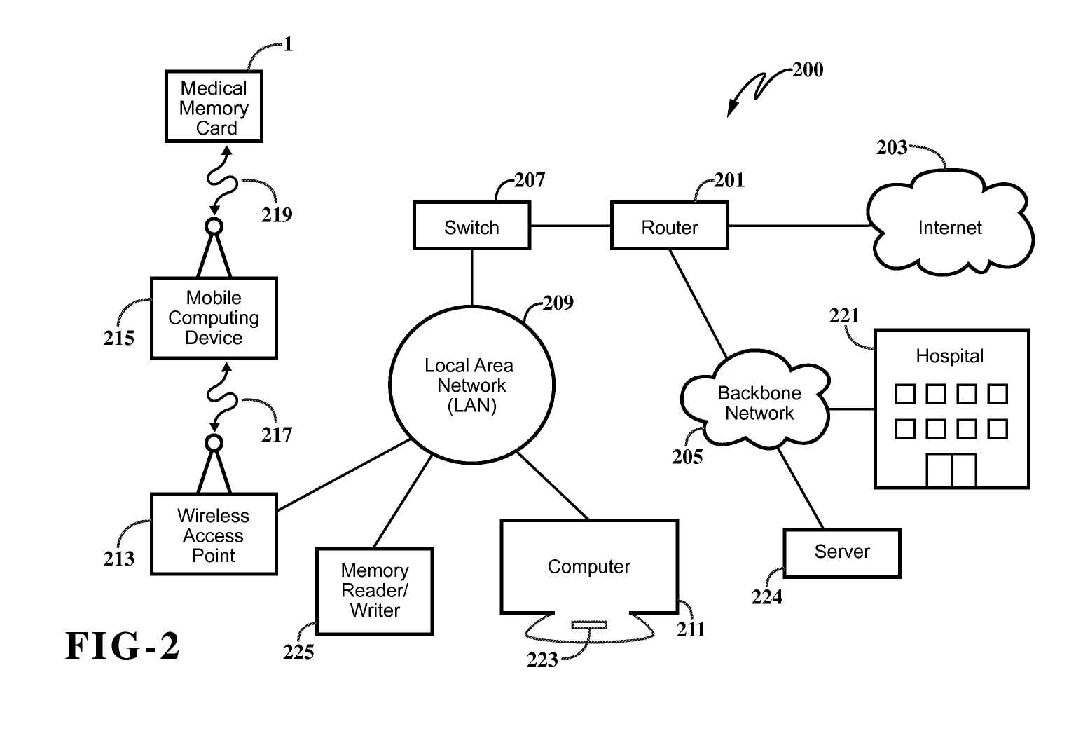

FIG. 2 shows one sample of a network or network environment 200 where the memory device 1 can operate. Network environment 200 may include a network router 201 connected to the internet 203 as well as a large backbone network 205. A network switch 207 may connect router 201 to a local area network (LAN) 209. A sample computer 211, a memory reading device or memory reader/writer 225 and a wireless access point 213 may be connected to LAN 209. Memory reader/writer 225 may be designed to interface primarily with one or more memory devices 1. Reader/writer 225 may be a magnetic strip reader and writer which can read and write to magnetic strip 15 or an RFID reader and writer which can read and write to RFID tag or chip 17.

A mobile computing device 215 may be connected to access point 213 through a wireless link 217. Wireless signals 219 may provide a way for computing device 215 to access or retrieve data on memory device 1 and a way for data to be written to the memory of device 1. A network of a remote hospital 221 and a remote secure server 224 may be connected to backbone network 205. While network environment 200 has been described with some example components and networks, it will be understood that those of ordinary skill in this art could implement other networks in a wide variety of configurations and with a wide variety of different networking components.

Some of the basic interactions of some of the devices connected to network 200 are now discussed. To access and store (or read and write) information to the memory of device 1, a memory reader and writer may be provided. The memory reader can read or access data or information stored in the memory of device 1, whereas the memory writer can write or store data or information in the memory of device 1. The memory reader and memory writer may be a single unit or may be separate from one another. For simplicity, the memory reader and memory writer may be discussed herein as a combined memory reader and writer. Computing device 215 may have a memory reader and writer which can respectively wirelessly access and store data in the memory of device 1 through wireless communication signals 219 exchanged with the memory of memory device 1. This exchange provides for the movement of data (especially patient-specific information including medical data or information) between memory device 1 and remote hospital 221 or remote secure server 224. Hospital 221 may serve as a medical records storage entity, and server 224 may be at a medical records storage entity. Alternatively, computer 211 may have a memory reader and writer comprising a memory device reading slot 223 (which may be a card reading slot) into which memory device 1 can be inserted so that the memory reader of computer 211 can access and update (read and write) medical and other data or information stored on magnetic strip 15/chip 17 of memory device 1. In another configuration, there may be a separate memory reader and writer 225 which may be connected to LAN 209. Memory reader 225 may include a memory device reading slot (e.g., a card reading slot) that memory device 1 can be placed near or inserted into so that RFID chip 17 and/or magnetic strip 15 can be read and/or written to. Memory reader 225 is designed primarily to work with memory devices 1 and may be configured to work exclusively with memory devices 1.

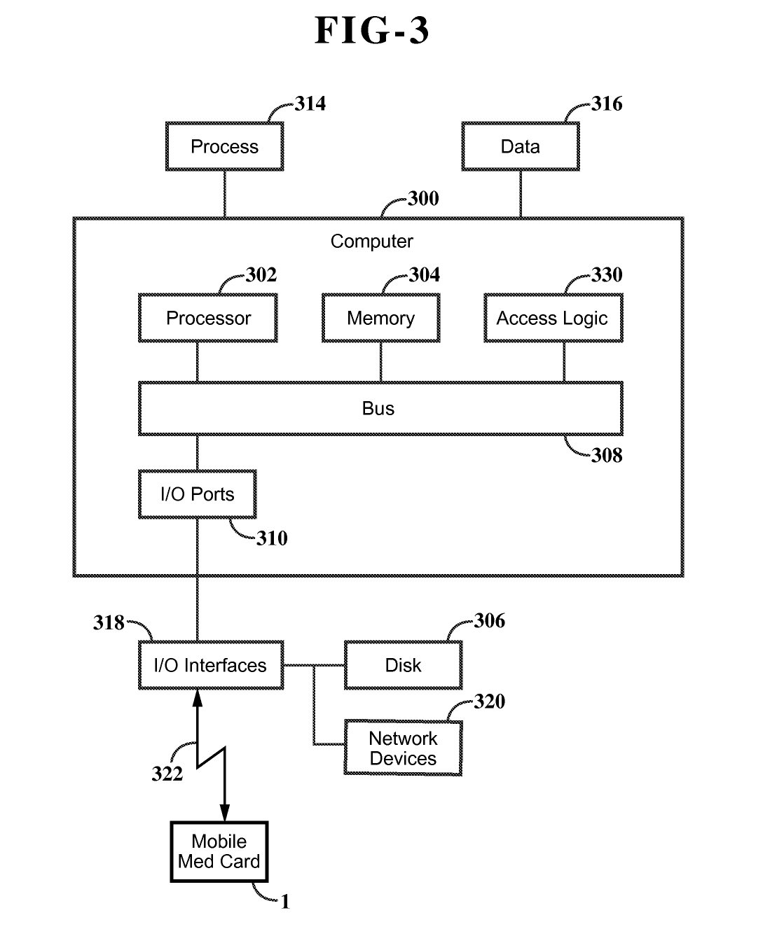

FIG. 3 shows a sample computing device in which example systems and methods described herein, and equivalents, may operate. The sample computing device may be a computer 300 that includes a processor 302, a memory 304, and input/output ports 310 operably connected by a bus 308. This computer 300 can be a desktop computer, laptop, an iPad device, mobile phone or another electronic device as understood by those of ordinary skill in the art.

In one example, computer 300 may include a memory device access logic 330 that may be configured to securely retrieve data from and securely write data to memory device 1. For example, memory device access logic 330 can access RFID tag 17 of memory device 1 via a wireless link 322 included as part of I/O interfaces 318. In different examples, access logic 330 may be implemented in hardware, software, firmware, and/or combinations thereof. Thus, logic 330 may provide a means (e.g., hardware, software and/or firmware) for securely accessing and/or updating memory device 1. While this logic 330 is illustrated as a hardware component attached to bus 308, it will be appreciated that access logic 330 could be implemented in processor 302.

“Processor” and “Logic”, as used herein, include but are not limited to hardware, firmware, software and/or combinations of each to perform a function(s) or an action(s), and/or to cause a function or action from another logic, method, and/or system. For example, based on a desired application or need, logic and/or a processor may include a software controlled microprocessor, discrete logic, an application specific integrated circuit (ASIC), a programmed logic device, a memory device containing instructions, or the like. Logic and/or a processor may include one or more gates, combinations of gates, or other circuit components. Logic and/or a processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

Generally, processor 302 may be a variety of various processors including dual microprocessors and other multi-processor architectures. A memory 304 may include volatile memory and/or non-volatile memory, Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM),

A disk 306 may be operably connected to computer 300 via, for example, an input/output interface 318 and an input/output port 310. Disk 306 may be, for example, a magnetic disk drive, a solid state disk drive, a floppy disk drive, a tape drive, a Zip drive, a flash memory card, and/or a memory stick. Furthermore, disk 306 may be a CD-ROM, a CD recordable drive (CD-R drive), a CD rewritable drive (CD-RW drive), and/or a digital video ROM drive (DVD ROM). Memory 304 can store a process 314 and/or data 316, for example. Disk 306 and/or memory 304 can store an operating system that controls and allocates resources of computer 300.

Bus 308 may be a single internal bus interconnect architecture and/or other bus or mesh architectures. While a single bus is illustrated, it will be appreciated that computer 300 may communicate with various devices, logics, and peripherals. Bus 308 can be of various types including, for example, a memory bus, a memory controller, a peripheral bus, an external bus, a crossbar switch and/or a local bus.

Computer 300 may interact with input/output devices via I/O interfaces 318 and input/output ports 310. Such input/output devices may be, for example, a keyboard, a microphone, a pointing and selection device, cameras, video cards, displays, disk 306, network devices 320, and so on. Input/output ports 310 may include, for example, serial ports, parallel ports, and USB ports.

Computer 300 can operate in a network environment and thus may be connected to network devices 320 via I/O interfaces 318 and/or I/O ports 310. Through network devices 320, computer 300 may interact with sample network 200 of FIG. 2. Through the network, computer 300 may be logically connected to remote computers. Networks with which computer 300 may interact include, but are not limited to, a local area network (LAN) such as LAN 209, a wide area network (WAN) and other networks. The networks may be wired and/or wireless networks.

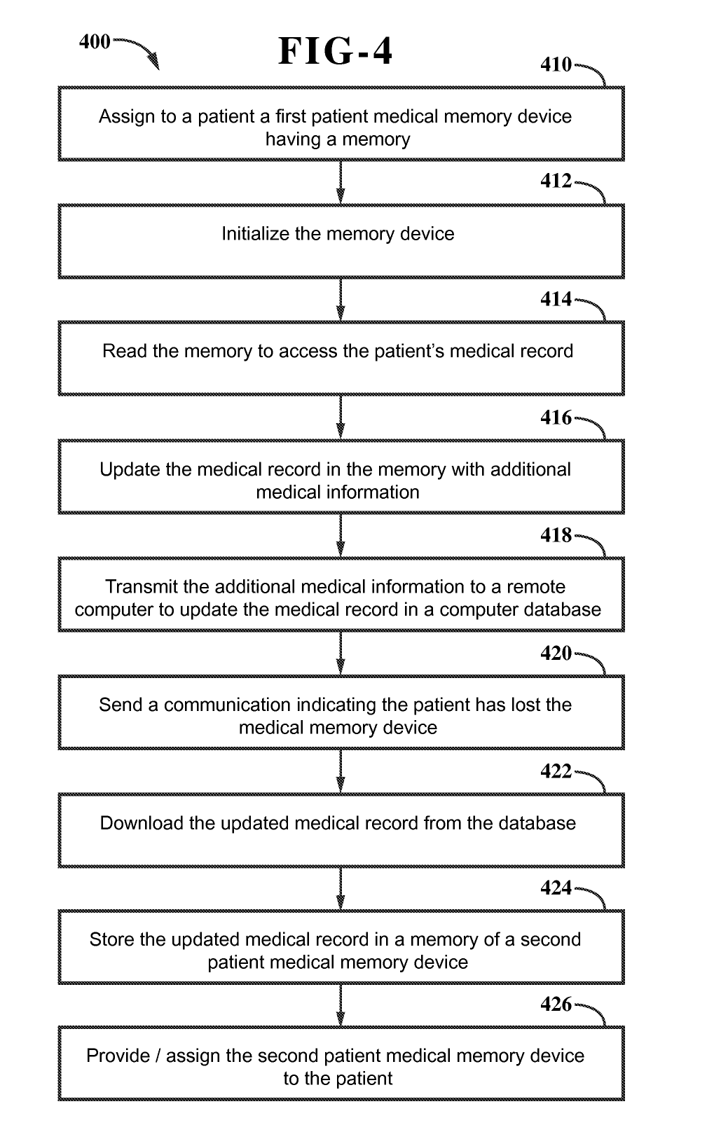

The use and operation of memory device 1 are now described. One method 400 of using memory device 1 may include the steps shown in the blocks of the FIG. 4 flowchart. It will be understood that the order of the steps in the blocks may vary although the method may be described herein in the order shown. Method 400 may include various steps, such as providing and assigning to a patient a first patient medical memory device having a memory (block 402); initializing the memory device (block 404); reading the memory to access the patient's medical record (block 406); updating the medical record in the memory with additional medical information (block 408); transmitting the additional medical information to a remote computer to update the medical record in a computer database (block 410); sending a communication indicating the patient has lost the medical memory device (block 412); downloading the updated medical record from the database (block 414); storing the updated medical record in a memory of a second patient medical memory device (block 416); and providing and assigning the second patient medical memory device to the patient (block 418). All of these steps may occur at a given medical facility at which a healthcare professional sees the patient although some of the steps may occur elsewhere.

The medical facility may be, for example, a hospital; an immediate or urgent medical care facility; a rehabilitation facility; a medical doctor's office; a dentist's office, a radiologist's office; a chiropractor's office; a physical therapist's office; an occupational therapist's office; an office or facility at which various types of healthcare professionals may work; or a billing processing company. Healthcare professionals may include those who work in various fields such as medical, nursing, midwifery, dentistry and other health professions such as occupational therapy, pharmacy, physical therapy, paramedicine, respiratory therapy, radiography and so forth. Healthcare professionals may include, for example, various types of medical doctors, medical billing representatives, dentists, pharmacists, physician assistants, nurses, midwives, dietitians, therapists, psychologists, psychiatrists, chiropractors, social workers, phlebotomists, physical therapists, respiratory therapists, occupational therapists, audiologists, speech pathologists, optometrists, ophthalmologists, emergency medical technicians, paramedics, anesthesiologists, radiologists, dieticians, rehabilitation care practitioners (e.g. physiatrists, rehabilitation nurses, clinical nurse specialists, nurse practitioners, physiotherapists, orthotists, prosthetists, occupational therapists, recreational therapists, audiologists, speech and language pathologists, respiratory therapists, rehabilitation counselors, physiotherapy technicians, orthotic technicians, prosthetic technicians, personal care assistants) and so forth.

Many memory devices 1 may be owned by the inventors or an organization and licensed to outside parties, physicians, clinics, hospitals and/or insurance parties. The issuance or assignment of a given memory device 1 (block 402) to a patient may be to a single person or a family or other groups of people. Memory device 1 may replace a person's insurance card or be in addition thereto. This issuance or assignment of memory device 1 may occur at a medical facility by a healthcare professional or staff of a healthcare professional. Thus, for instance, a healthcare facility may maintain a plurality of unassigned memory devices 1 which can be assigned to a patient, such as when the patient visits the medical facility. The assignment of device 1 may occur in other locations and may be done by any organization which owns devices 1 or which has been granted a license or is otherwise authorized to issue or assign devices 1 to respective patients. A given memory device 1 may thus be possessed by and/or owned by a given patient once issued or assigned to that patient. The patient may easily carry memory device 1 with them wherever they go, and will ordinarily bring device 1 to any given medical facility at which the patient is to be diagnosed and/or treated.

Memory device 1 is initialized (block 404) with medical health related data or medical information of its user, that is, the patient to whom memory device 1 is issued or assigned. This may be done by reading and writing RFID chip 17 with a wireless electronic device or RFID reader. Alternatively, a magnetic memory reader (e.g., a magnetic strip reader) may be used to read and write to magnetic strip 15. Memory reader 225 may be used to access data and write/update data on memory device 1. Initialization information may include patient-specific information (patient identification information, medical information and otherwise) such as the patient's: name, address and/or other contact information (phone number, email address, etc), date of birth, social security number, insurance information, guarantor information, current medications (being taken by the patient), medical conditions, chronic disease information, diabetic information, primary care physician, referring physician, allergy information, past prior medical records and the like. The reading and writing to memory device 1 may be with encrypted data.

While initializing memory device 1, the electronic device that interfaces with memory device 1 may access data stored at hospital 221 (e.g., stored on a secure server of hospital 221) or a secure server 224 on network 200 of FIG. 2. If an existing patient has medical records that exist at hospital 221 and/or secure server 224, these records may be retrieved and then written to memory device 1 during the initialization of memory device 1 (block 404). An organization may have secure servers or other secure data devices attached to a network similar to network 200 of FIG. 2. In this case, the device accessing information on memory device 1 may exchange data with the organization's secure servers to initialize memory device 1. Data exchange with the memory device 1 may be performed using the health level 7 (HL7) standard, which provides a framework for the exchange, integration, sharing and retrieval of electronic health information.

Alternative ways to initialize memory device 1 include having the patient complete an online (internet based) registration form and then having this information loaded onto memory device 1 at a facility which handles memory device 1 before memory device 1 is sent to the patient. Alternatively, initialization information can be manually loaded into memory device 1 at an offsite or central office location or physician's office.

After memory device 1 has been initialized, device 1 may be provided or presented to the patient during a visit to a doctor, hospital or other healthcare professional or provider. When the patient visits a medical facility, he or she brings device 1 to the facility and presents it to a healthcare professional or staff member so that the memory of device 1 can be rapidly read (block 406) by memory reader 225 to access from a remote database of a computer or server medical information of the patient including the patient's medical history. As noted above, other devices may be used to read the memory of memory device 1. Rapidly reading memory device 1 allows medical personnel to quickly have access to a patient's personal and biometric data as well as the patient's medical record, which may include essentially the entire medical history of the patient. At the same time memory device 1 is read of thereafter, the information read may be displayed on a display screen of any suitable electronic device, for instance, the display screen or monitor of computer 211, which may be located at a given medical facility at which the patient is visiting a healthcare professional for medical diagnosis and/or treatment.

After a patient receives a medical diagnosis, treatment and/or the like, the healthcare professional creates additional medical information (or a set of medical information) based on the diagnosis and/or treatment. That is, the medical diagnosis and/or treatment is recorded in writing such as on a computer. Typically, either the healthcare professional or one of his or her staff members records this information in writing or various symbols by inputting the new set of medical information into a computer file with one or more input devices, such as a keyboard, mouse and/or microphone, for example. This inputting typically occurs at the medical facility where the patient visited the healthcare professional and where memory reader and writer 225 may be located. Once this new set of medical information has been entered in the computer file, it may then be accessed by memory reader and writer 225.

Then, this new medical information derived from the visit at the medical facility is written (block 408) to the memory of memory device 1 to update the patient's medical history, using memory reader/writer 225 or any other suitable writing device or memory writer. Writing or storing the medical information in the memory of device 1 allows memory device 1 to essentially always carry a patient's entire medical history (or at least a substantial portion thereof) no matter where the patient goes for medical care in the future. When memory device 1 is updated, a similar update of the patient's medical record may be made on a memory or database of the secure servers so that if the patient loses his or her medical memory device, another copy of the medical record is available on those servers so that the patient may still access his or her medical record therefrom.

Thus, the additional medical information derived from the visit to the healthcare professional at the medical facility, along with the medical and other information which was previously stored in the memory of device 1, is transmitted to a remote computer or server to update the medical record in a computer database (block 410). This database may be the same database from which earlier medical and other information was downloaded previously so that this downloaded information could be used in the initialization of the memory of device 1, or at some time after initialization and before a given patient visit with a healthcare professional.

If a given medical facility (e.g., a smaller doctor's office) is unwilling or unable to update memory device 1 because they don't have an appropriate memory reader or for other reasons, the medical information related to the patient's visit to that office or facility can be updated at an offsite location to update memory device 1 with medical information about that visit. The patient's insurance information may be stored in the memory of device 1 along with the medical information, and may be updated when there are changes to the patient's insurance information when memory device 1 is read by a memory reader, such as when the patient visits a medical facility. Thus, the patient's medical information and insurance information may be stored and updated in the memory of device 1.

If the patient loses his or her memory device 1, as mentioned above, the patient or a healthcare professional or staff member at a medical facility may send a communication indicating the patient has lost the medical memory device (block 412). This communication may, for instance, be sent to a medical records storage entity such as hospital 221 or a medical records storage entity at which server 224 is located. This communication may also be sent or transmitted to the computer program which is configured to access the database whereby the computer program may allow downloading access to the database. The updated medical record from the database may then be downloaded (block 414) and written to or stored in a memory of a second patient medical memory device (block 416), such as with memory reader/writer 225, which may be located at a medical facility. The second or replacement patient medical memory device may then be assigned and provided to the patient (block 418), as was the first memory device 1 prior to its being lost. The patient may then use the replacement device 1 in the same manner as the first device 1.

One method may involve the maintaining or storing of various sets of patient-specific information including sets of medical information of given patients in a computer database (such as that of server 224 or the server of hospital 221) wherein each set of medical information may include data or information which is derived from one or more visits of a given patient with a medical professional typically at a medical facility (although visits may also be at a patient's home). These sets of medical information may include the typical vitals of the patient at a given time (e.g. the patient's temperature, blood pressure, heart rate, weight etc.) as well as current medications (being taken by the patient), medical conditions, chronic disease information, diabetic information, allergy information, past prior medical records, a diagnosis, a treatment, a treatment plan, a prescription for a medication/drug to be taken by the patient and so forth. The sets of patient-specific information may also include the patient-specific information noted further above, such as name, address, date of birth and so forth.

A computer program is provided to achieve various steps of the method. The computer program is configured to access the computer database, in which are stored the medical records of a large number of people/patients in respective patient-specific medical record files. Each medical record typically has a substantial amount of medical information about the given person/patient, making up a complete medical history of that patient, or at least as complete as has been possible during the inputting of medical information into the database for a given patient. Once a given patient has a medical record file in the database, that medical record file may be updated by inputting or storing additional medical information in that file, so that the medical record of the given patient may be kept up to date and available for future use. At a given time, each medical record may include a set of medical information, to which may be added additional sets of medical information, wherein each set of medical information is related to a specific patient and each additional set is derived from a visit of that patient with a healthcare professional.

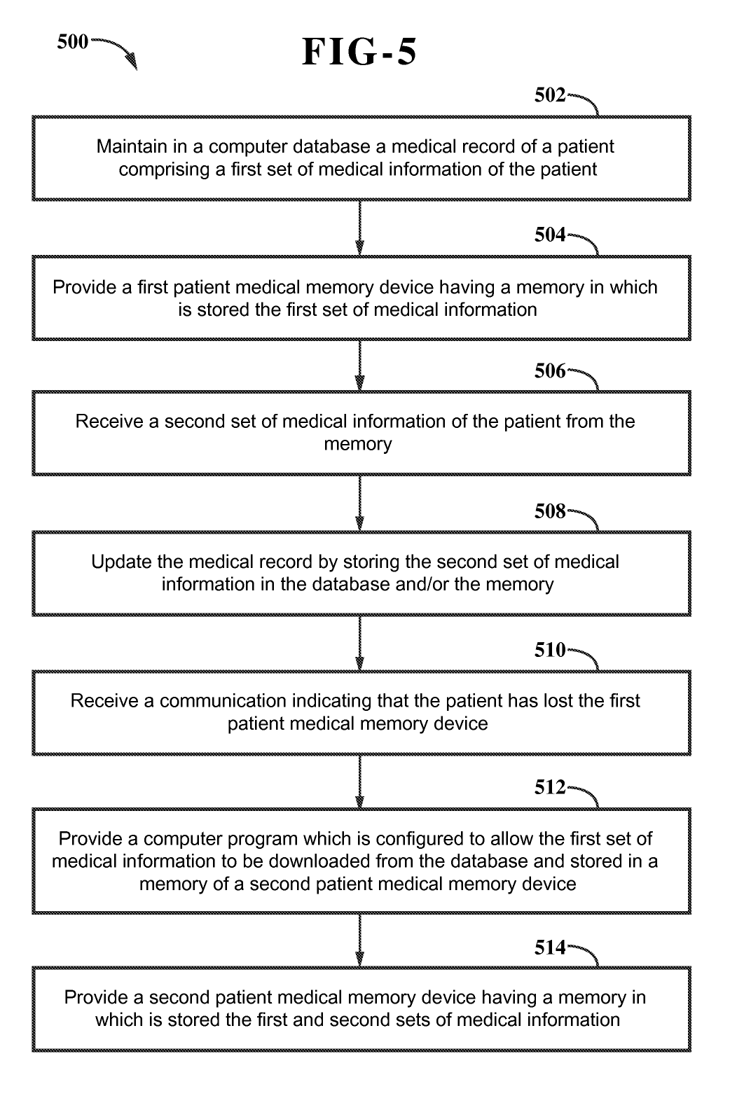

FIG. 5 shows such a method (500), which may include the steps shown in blocks 502-514. Thus, the method may include maintaining in a computer database a medical record of a patient comprising a first set of medical information of the patient (block 502); providing a first patient medical memory device having a memory in which is stored the first set of medical information (block 504); receiving a second set of medical information of the patient from the memory (block 506); updating the medical record by storing the second set of medical information in the database and/or the memory (block 508); receiving a communication indicating that the patient has lost the first patient medical memory device (block 510); providing a computer program which is configured to allow the first set of medical information to be downloaded from the database and stored in a memory of a second patient medical memory device (block 512); and providing a second patient medical memory device having a memory in which is stored the first and second sets of medical information (block 514).

The medical record may be stored or maintained in a secure computer database of a secure server, such as at hospital 221 or server 224. The medical information may be encrypted whereby the first set of medical information may be stored in the database in encrypted form as encrypted medical information, and also be stored in the memory of memory device 1 in encrypted form as encrypted medical information. Thus, the encrypted medical information may need to be decrypted. Encryption and decryption of the information may occur respectively at an encryption device and a decryption device which may be part of the memory reader and writer such as 225. Encryption and decryption of the information may also occur respectively at an encryption device and a decryption device which may be part of the remote server at 224 or at hospital 221.

Providing the first memory device may include providing or delivering the first memory device to the patient. This delivery may occur at a medical facility and may be carried out there by an authorized healthcare professional or an authorized staff member working at the facility by handing the memory device to the patient. This delivery to the patient may occur after device 1 has been assigned to the patient as discussed further above. This delivery may also be made or initiated by depositing the first memory device with a delivery service with instructions to the delivery service (such as via the patient's delivery address) to deliver the first memory device to the patient, or to a medical facility (such as via the medical facility's delivery address) which in turn delivers the memory device to the patient as noted above.

The method may include providing a computer program which is configured to allow remote downloading access to the first set of medical information which is maintained in the database. For instance, the computer program may allow such access to an authorized user via a computer with the use of a password or a code which meets the requirement of the computer program that such downloading access may be permitted only to an authorized user or device. The first set of medical information may thus be remotely downloaded from the database and stored in the memory of the first memory device. The authorized user may be, for example, the patient, a healthcare professional or the staff of a healthcare professional. The authorized device may be a memory reader/writer which is configured to read the memory of the memory device, to access the database via computer-related links to download the first set of information and to store or write the first set to the memory of the first memory device.

The method may also involve receiving a communication indicating that the patient has lost the first memory device, and providing a second or replacement patient medical memory device having a memory in which may be stored the first and second sets of medical information, thus providing to the patient a replacement copy of his or her updated medical record. This step of receiving the communication may occur at a server or computer where the database is located. Replacing the memory device with the updated medical record may be achieved by providing a computer program which is configured to allow the first and second sets of medical information to be downloaded from the database and stored in a memory of the second/replacement patient medical memory device. This may, for example, be permitted only to an authorized user in the same or similar manner as discussed above.

The method may also include receiving multiple additional sets of medical information—e.g., third, fourth, fifth, sixth, etc. sets of medical information—which are used to update a given medical record by storing these sets in the medical record file of the corresponding patient. Thus, for example, the method may include receiving a third set of medical information of a given patient from the memory of device 1 and updating that patient's medical record by storing the third set of medical information in the database, specifically in that patient's medical record file. Because the patient may have visited the same or different medical professionals at the same or different medical facilities, the second set of medical information, for example, may be received via a first memory reader located at a first medical facility, and the third set of medical information may be received via the first memory reader or via a second memory reader located at the first medical facility or at a second different medical facility.

The additional sets of medical information may be remotely accessed in the same manner as described above with respect to the first set, and thus, for instance, may be accessible only by an authorized user or device. The additional sets of medical information may then be stored in the memory of memory device 1 to update the given patient medical record with these additional sets of medical information. Moreover, the computer program may be configured to allow the database to be updated with the second and other sets of medical information in the same manner as discussed above regarding the first set. All sets of medical information may be encrypted and decrypted as noted above regarding the first set. The memory reader/writer may be unique to the system such that it only communicates to the database, and may have an encryption device to send the first and second sets of medical information in encrypted form. The computer program may include a controlled access gate which allows only authorized users to access the various sets of medical information from the database. Once a given set or sets of medical information is accessed from the database, the medical record of the patient comprising the set or sets of medical information may be sent or transmitted from the database to a computer of a healthcare professional.

It is noted that the steps of methods 400 and 500 may be used together, whereby the steps of each method may be incorporated into the other method. Thus, an apparatus, system and method are provided which allow for the updating of a patient's medical record in an ongoing manner over many years, even throughout the lifetime of the patient, so that the patient and healthcare providers may always have access to the patient's medical record. The access and ability to update the patient's medical record (in the memory of device 1 and the database), in addition to the ability of the patient to carry memory device 1 anywhere, allows any healthcare professional that the patient visits to have a vastly improved knowledge of the patient's medical issues in a broader context than what the healthcare professional might otherwise glean simply from a given visit. The system and method also provide a way to maintain a substantially complete medical record separate from the patient as a backup in case memory device 1 is lost.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

1. A method comprising the steps of:
reading with a memory reader a memory of a first patient medical memory device of a patient to access a medical record of the patient comprising a first set of medical information; and
storing in the memory with a memory writer a second set of medical information to update the medical record, wherein the second set of medical information is derived from a visit of the patient with a healthcare professional at a first medical facility where the memory reader is located.

2. The method of claim 1 further comprising the step of providing the first patient medical memory device to the patient.

3. The method of claim 1 further comprising the step of assigning the first patient medical memory device to the patient.

4. The method of claim 1 further comprising the step of initializing the first patient medical memory device by storing the first set of medical information in the memory.

5. The method of claim 4 further comprising the step of downloading the first set of medical information from a remote computer database before the step of initializing.

6. The method of claim 1 further comprising the step of displaying the medical record on a display screen at the first medical facility.

7. The method of claim 1 wherein the step of reading comprises reading a radio frequency identification tag (RFID) with an RFID tag reader.

8. The method of claim 1 wherein the step of reading comprises reading an electromagnetic strip with an electromagnetic strip reader.

9. The method of claim 1 further comprising the step of transmitting the second set of medical information to a remote computer to update the medical record in a computer database.

10. The method of claim 9 further comprising the step of accessing the second set of medical information by reading the memory with a memory reader; and
wherein the step of transmitting comprises transmitting the second set of medical information which was accessed by reading the memory.

11. The method of claim 1 further comprising the step of storing the first set of medical information in the memory with a memory writer.

12. The method of claim 11 further comprising the step of downloading the first set of medical information from a remote computer database before the step of storing the first set of medical information.

13. The method of claim 1 further comprising the step of inputting the second set of medical information into a computer file with an input device at a medical facility where the memory reader is located.

14. The method of claim 1 wherein the first set of medical information includes medical information derived from a visit of the patient with a healthcare professional at a second medical facility different from the first medical facility.

15. The method of claim 1 further comprising the step of sending the medical record of the patient comprising the first and second sets of medical information through a network to a computer of a medical records storage entity.

16. The method of claim 1 further comprising the step of sending a communication indicating the patient has lost the first patient medical memory device.

17. The method of claim 16 further comprising the steps of downloading from a remote computer database the first and second sets of medical information; and
storing the first and second sets of medical information in a memory of a second patient medical memory device.

18. The method of claim 17 further comprising the step of assigning the second patient medical memory device to the patient.

19. A method comprising the steps of:
maintaining in a computer database a medical record of a patient comprising a first set of medical information of the patient;
providing a first patient medical memory device having a memory in which is stored the first set of medical information;
receiving a second set of medical information of the patient from the memory; and
updating the medical record by storing the second set of medical information in the database.

20. A system comprising:
a patient medical memory device having a memory in which is stored a first set of medical information of a patient to which the memory device is assigned; and
a memory reader and writer capable of reading the memory to access the first set of medical information and writing to the memory to store a second set of medical information in the memory.
